(19) United States
(12) Patent Application Publication
(10) Pub. No.: US 2007/0047670 A1
(43) Pub. Date: Mar. 1, 2007

(54) High-frequency detection mechanism and automatic gain control system utilizing the same

(75) Inventor: Hung-Kun Chen, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/215,102

(22) Filed: Aug. 30, 2005

(51) Int. Cl. H04L 27/00

(52) U.S. Cl. 375/316

(57) ABSTRACT

An automatic gain control mechanism with high-frequency detection. During a predetermined period, the cumulative strength of the real part of a complex-valued input signal is compared with that of the imaginary part of the complex-valued input signal. The zero crossings in either the real part or imaginary part of the complex-valued input signal are selectively totaled contingent upon which part of the complex-valued signal possesses the larger cumulative strength. If the zero crossings total exceeds a predetermined threshold, the automatic gain control mechanism starts detecting a normal packet signal and activating gain control over the detected normal packet signal.

### BACKGROUND

The invention relates to communications receivers, and more particularly to a high-frequency detection mechanism for use in automatic gain control systems.

With the rapidly growing demand for cellular, mobile radio and other wireless transmission services, there has been an increasing interest in exploiting various technologies to provide reliable, secure, and efficient wireless communications. Referring to FIG. 1, an exemplary wireless communications receiver is illustrated. A radio frequency (RF) signal received by an antenna 102 is coupled to a channel filter 104 to separate a signal at a particular frequency, normally referred to as a channel from other components of the received signal. The output of the filter 104 is applied to an amplifier 106 that has variable or controllable gain. From the amplifier 106 the signal is split into in-phase (I) and quadrature (Q) components by a known quadrature mixer 108. Also included, but not shown, with the quadrature mixer 108 is a down-conversion stage for conversion of the RF signal down to a baseband frequency as is known. Anti-aliasing filters 110a and 110b filter out image signal components from the I channel and Q channel signals, and limit the input bandwidth sampled by analog-to-digital converters (ADCs) 112a and 112b. Digital outputs from the ADCs 112a and 112b are sent to an automatic gain control (hereinafter abbreviated as AGC) system 114 that generates a gain control signal to regulate the amplifier 106.

The amplifier 106 in FIG. 1 is required to ensure that the signals input to each of the ADCs 112a and 112b are within the dynamic operating range of the ADC. If the received amplitude is relatively low, then a relatively large gain is applied to the amplifier 106, whereas a relatively small gain is applied when the received signal amplitude is relatively high. AGC systems have been known and widely used. In general, the gain control algorithm used by an AGC system can be designed to accommodate virtually any desired ADC dynamic range. However, some RF transmitters may turn on power amplifiers therein before associated baseband processors begin to send modulated signals, leading to direct current (hereinafter abbreviated as DC) leakage in front of a normal packet signal. Receivers thus pick up an incorrect power level arising from the DC leakage, which, in turn, causes the AGC system to make a wrong decision. Such DC or near DC components in the received signal can result in severe degradation of AGC system performance. Typically, the frequency of the normal packet signal in the received signal is higher than that of the DC or near DC components. Therefore, what is needed is a high-frequency detection mechanism for use in AGC systems to ignore the DC or near DC components, addressing the problems associated with the related art.

### SUMMARY

Embodiments of the present invention are generally directed, but not limited, to a high-frequency detection mechanism and automatic gain control system for use in a wireless communications receiver. According to one aspect of the invention, a method of high-frequency detection comprises the steps of totaling the zero crossings in the real part of a complex-valued input signal during a predetermined period; totaling the zero crossings in the imaginary part of the complex-valued input signal during the predetermined period; comparing the cumulative strength of the real part of the complex-valued input signal with that of the imaginary part of the complex-valued input signal during the predetermined period; choosing the zero crossings total corresponding to which part of the complex-valued input signal possesses the larger cumulative strength during the predetermined period for use as an effective value; and determining that there is a high-frequency component in the complex-valued input signal if the effective value exceeds a predetermined threshold.

According to another aspect of the invention, a method of automatic gain control in a wireless communications receiver comprises the steps of receiving a complex-valued signal; comparing the cumulative strength of the real part of the complex-valued signal with that of the imaginary part of the complex-valued signal during a predetermined period; totaling the zero crossings in either the real part or imaginary part of the complex-valued signal during the predetermined period contingent upon which part of the complex-valued signal possesses the larger cumulative strength; and if the zero crossings total exceeds a predetermined threshold, then starting to detect a normal packet signal and activating a gain control mechanism for regulation of the normal packet signal.

According to yet another aspect of the invention, an embodiment of an automatic gain control system is set forth in the disclosure. The automatic gain control system comprises a high-frequency detector, a packet detector, and a gain controller. The high-frequency detector receives a complex-valued signal and generates a trigger signal. In response to assertion of the trigger signal, the packet detector starts detecting a normal packet signal. The gain controller applies a controlled gain to the detected normal packet signal. Preferably, the high-frequency detector comprises means for totaling the zero crossings in the real part of the complex-valued signal during a predetermined period; means for totaling the zero crossings in the imaginary part of the complex-valued signal during the predetermined period; means for comparing the cumulative strength of the real part of the complex-valued input signal with that of the imaginary part of the complex-valued input signal during the predetermined period, means for choosing the zero crossings total corresponding to which part of the complex-valued input signal possesses the larger cumulative strength during the predetermined period for use as an effective value; and means for asserting the trigger signal if the effective value exceeds a predetermined threshold.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a block diagram of an exemplary wireless communications receiver;

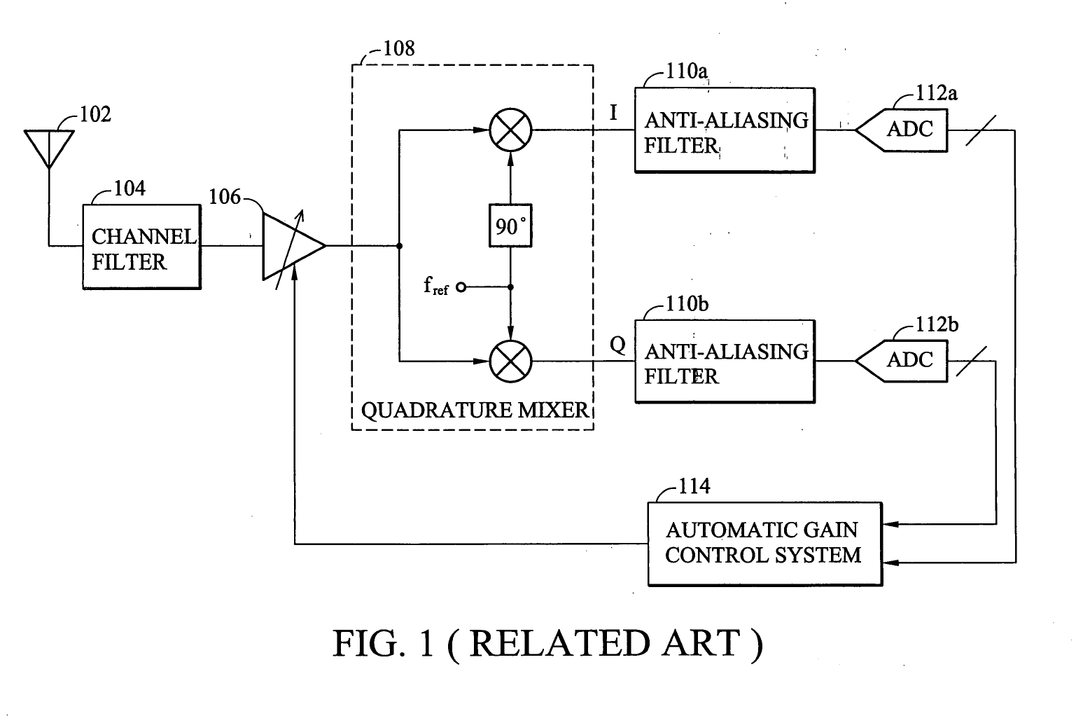

FIG. 2 is a flowchart of high-frequency detection according to an embodiment of the invention;

FIG. 3 is a flowchart of automatic gain control in conjunction with high-frequency detection according to an embodiment of the invention; and

FIG. 4 is a block diagram of an AGC system according to an embodiment of the invention.

### DETAILED DESCRIPTION

With reference to the accompanying figures, exemplary embodiments of the invention will now be described. The exemplary embodiments are described primarily with reference to block diagrams and flowcharts. As to the flowcharts, each block therein represents both a method step and an apparatus element for performing the method step. Herein, the apparatus element may be referred to as a means for, an element for, or a unit for performing the method step. Depending upon the implementation, the apparatus element, or portions thereof, may be configured in hardware, software, firmware or combinations thereof. As to the block diagrams, it should be appreciated that not all components necessary for a complete implementation of a practical system are illustrated or described in detail. Rather, only those components necessary for a thorough understanding of the invention are illustrated and described. Furthermore, components which are either conventional or may be readily designed and fabricated in accordance with the teachings provided herein are not described comprehensively.

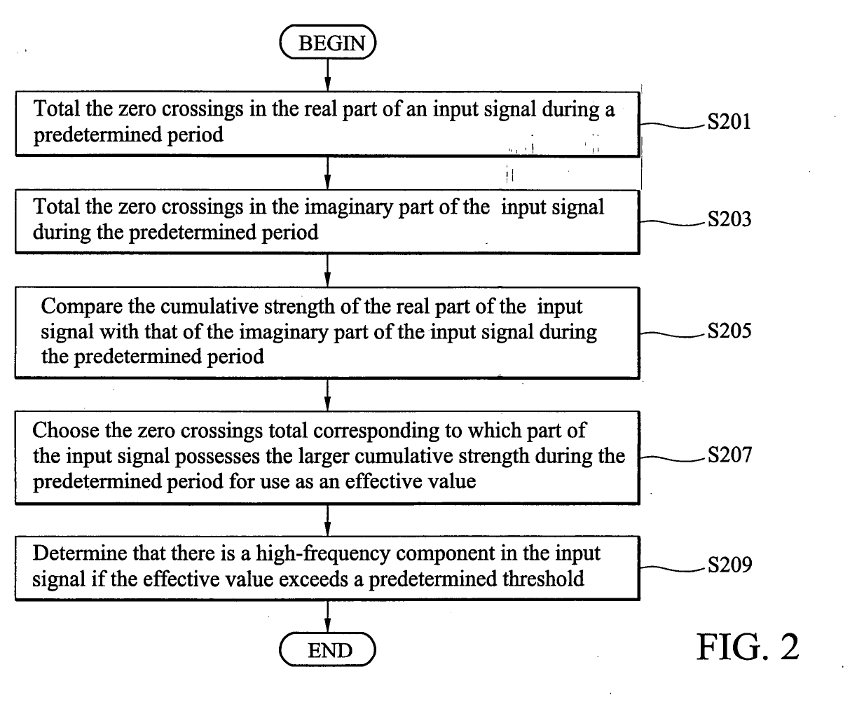

FIG. 2 shows primary steps used for high-frequency detection in a wireless communications receiver according to an embodiment of the invention. In step S201 of FIG. 2, the zero crossings in the real part of a complex-valued input signal are totaled during a predetermined period. Likewise, the zero crossings in the imaginary part of the complex-valued input signal are totaled during the same period in step S203. Here the input signal in the time domain is denoted by a sequence of discrete samples, {r(n)}, in which r(n) is complex-valued and indicates a sample of {r(n)} at time instant n. Then the real part (i.e. I component) and the imaginary part (i.e. Q component) of the input signal are identified by r_{I}(n) and r_{Q}(n), respectively. A zero crossing between two consecutive samples can be detected by XORing the sign bit of a current sample with that of a previous sample. In one embodiment, the number of zero crossings in the real and the imaginary parts of the input signal are counted by:

$${X}_{I} = {\sum }_{n = 1}^{N} I [ {r}_{I} ( n - 1 ) \cdot {r}_{I} ( n ) \leq 0 ]$$

$$and$$

$${X}_{Q} = {\sum }_{n = 1}^{N} I [ {r}_{Q} ( n - 1 ) \cdot {r}_{Q} ( n ) \leq 0 ]$$

where X_{I} is the zero crossings total of the real part, X_{Q} is the zero crossings total of the imaginary part, N denotes the number of samples of the input signal within the predetermined period, and I[.] denotes an indicator function in which I[A]=1 if expression A is true; otherwise, I[A]=0. Next in step S205, the cumulative strength of the real part of the input signal is compared with that of the imaginary part of the input signal during the predetermined period. In this regard, during the predetermined period the cumulative strength of the real part of the input signal, S_{I}, and the cumulative strength of the imaginary part of the input signal, S_{Q}, are measured by:

$${S}_{I} = {\sum }_{n = 0}^{N - 1} {\vert {r}_{I} ( n ) \vert}^{2}$$

$$and$$

$${S}_{Q} = {\sum }_{n = 0}^{N - 1} {\vert {r}_{Q} ( n ) \vert}^{2}$$

where S_{I} and S_{Q} are in effect representative of the energy of the {r_{I}(n)} and {r_{Q}(n)} sequences over N number of samples. For simplicity, the square root of energy can be calculated instead so S_{I} and S_{Q} are approximated by:

$${S}_{I} = {\sum }_{n = 0}^{N - 1} \vert {r}_{I} ( n ) \vert$$

$$and$$

$${S}_{Q} = {\sum }_{n = 0}^{N - 1} \vert {r}_{Q} ( n ) \vert$$

By comparing S_{I} and S_{Q}, the high-frequency detection mechanism thus determines which part of the complex-valued input signal possesses the larger cumulative strength during the predetermined period. Rather than directly measuring the cumulative strength, the magnitude of the real part of the input signal and that of the imaginary part of the input signal are compared with each other on a sample-by-sample basis. Further, the number of samples at which the magnitude of the real part of the input signal are greater than or equal to that of the imaginary part of the input signal is counted during the predetermined period. That is,

$${M}_{I \geq Q} = {\sum }_{n = 0}^{N - 1} I [ \vert {r}_{I} ( n ) \vert \geq \vert {r}_{Q} ( n ) \vert ]$$

The count is checked to determine whether it is greater than half the number of samples of the complex-valued input signal within the predetermined period, namely M_{I≧Q}>N/2. If so, the cumulative strength of the real part of the input signal is approximately viewed as being larger than that of the imaginary part of the input signal. With continued reference to FIG. 2, the zero crossings total corresponding to which part of the input signal possesses the larger cumulative strength during the predetermined period is chosen as an effective value, Xₑ, in step S207. In other words, Xₑ is equal to X_{I} provided that S_{I}≧S_{Q}; otherwise, Xₑ is equal to X_{Q}. Finally, the high-frequency detection mechanism pursuant to step S209 determines that there is a high-frequency component in the input signal if the effective value Xₑ exceeds a predetermined threshold.

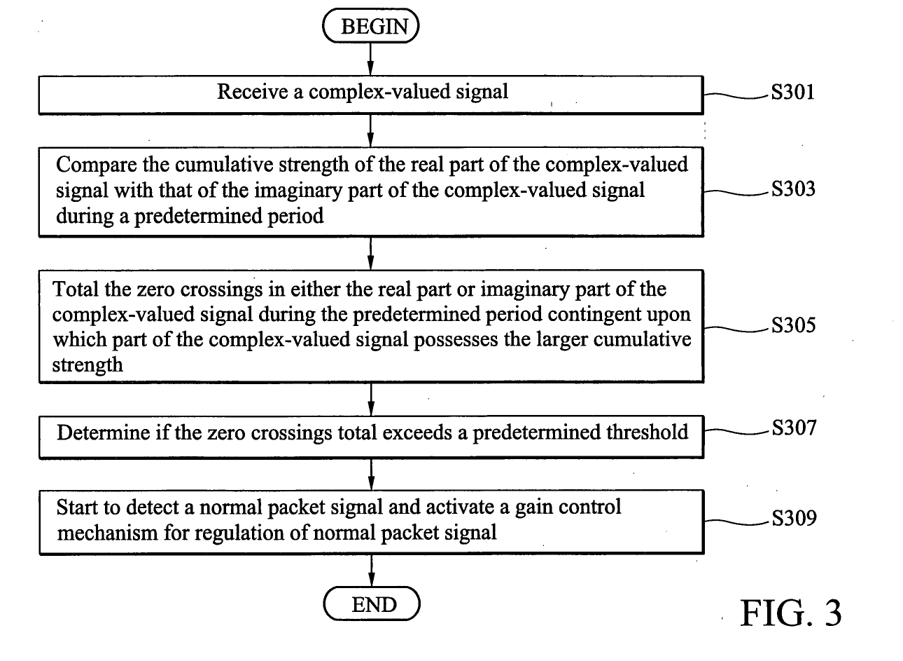

In light of the forgoing discussion, an automatic gain control (AGC) method is described herein from a flowchart of FIG. 3. As can be seen by reference to step S301, a complex-valued signal is received first. In step S303, during a predetermined period, the cumulative strength of the real part of the complex-valued signal is compared with that of the imaginary part of the complex-valued signal. Then in step S305, the zero crossings in either the real part or imaginary part of the complex-valued signal are totaled during that period contingent upon which part of the complex-valued signal possesses the larger cumulative strength. In step S307, the zero crossings total is checked to see if it exceeds a predetermined threshold. If so, the AGC method in step S309 starts to detect a normal packet signal and then activates a gain control mechanism for regulation of the normal packet signal; otherwise, transition to next states is not allowed in the AGC method. The gain control mechanism is beyond the scope of the invention and is not described in detail herein.

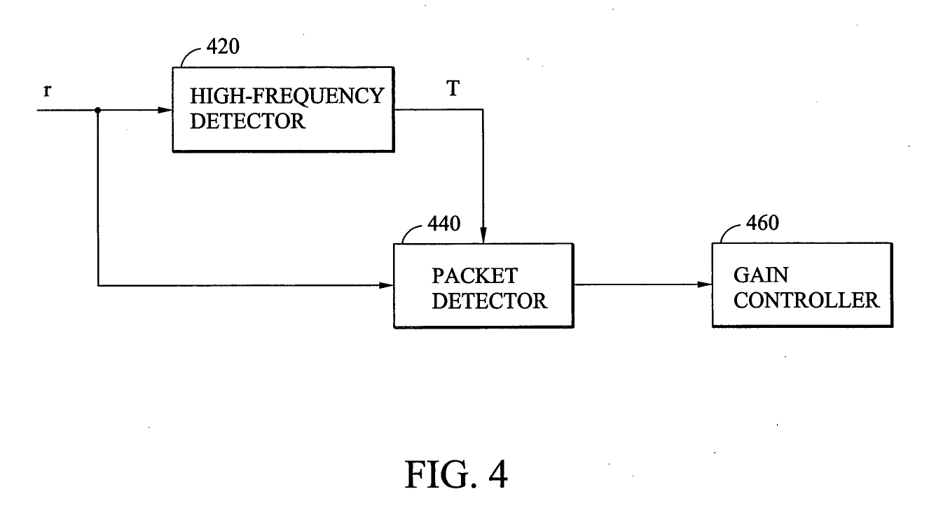

FIG. 4 is a block diagram of an AGC system 400 according to an embodiment of the invention. The AGC system 400 comprises a high-frequency detector 420, a packet detector 440, and a gain controller 460. As depicted, the high-frequency detector 420 receives a complex-valued signal, r, and generates a trigger signal, T. The high-frequency detector 420 preferably comprises: a means 422, for totaling the zero crossings in the real part of the complex-valued signal during a predetermined period; a means 424, for totaling the zero crossings in the imaginary part of the complex-valued signal during the predetermined period; a means 426, for comparing the cumulative strength of the real part of the complex-valued input signal with that of the imaginary part of the complex-valued input signal during the predetermined period; a means 428, for choosing the zero crossings total corresponding to which part of the complex-valued input signal possesses the larger cumulative strength during the predetermined period for use as an effective value; and a means 430, for asserting the trigger signal T if the effective value exceeds a predetermined threshold. In response to assertion of the trigger signal T, the packet detector 440 starts to detect a normal packet signal. Accordingly, the gain controller 460 applies a controlled gain to the detected normal packet signal.

It should be noted that each method step mentioned earlier also represents an apparatus element for performing the method step. Therefore, in one embodiment, the means 426 incorporated in the high-frequency detector 420 comprises means for comparing the magnitude of the real part of the complex-valued signal and that of the imaginary part of the complex-valued signal with each other on a sample-by-sample basis; means for counting the number of samples at which the magnitude of the real part of the complex-valued signal are greater than or equal to that of the imaginary part of the complex-valued signal during the predetermined period; and means for determining whether the count is greater than half the number of samples of the complex-valued signal within the predetermined period. In this manner, the means 426 decides to choose the zero crossings total of the real part of the complex-valued signal if the count is greater than half the number of samples. In an alternative embodiment, the means 426 incorporated in the high-frequency detector 420 comprises means for measuring S_{I}, the cumulative strength of the real part of the complex-valued signal during the predetermined period, by:

$${S}_{I} = {\sum }_{n = 0}^{N - 1} {\vert {r}_{I} ( n ) \vert}^{2}$$

or approximately by:

$${S}_{I} = {\sum }_{n = 0}^{N - 1} \vert {r}_{I} ( n ) \vert$$

Similarly, the means 426 also comprises means for measuring S_{Q}, the cumulative strength of the imaginary part of the complex-valued signal during the predetermined period, as follows:

$${S}_{Q} = {\sum }_{n = 0}^{N - 1} {\vert {r}_{Q} ( n ) \vert}^{2}$$

$$or$$

$${S}_{Q} = {\sum }_{n = 0}^{N - 1} \vert {r}_{Q} ( n ) \vert$$

In addition, the means 426 comprises means for determining which part of the complex-valued signal possesses the larger cumulative strength during the predetermined period by comparing S_{I} with S_{Q}.

A communications receiver pursuant to embodiments of the invention can protect an AGC system therein from picking up an incorrect power level due to DC leakage. Hence, using the principles and concepts disclosed above will enable performance improvement in the communications receiver. Furthermore, these embodiments of the invention may be implemented with any combination of logic in an application specific integrated circuit (ASIC) or firmware.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of high-frequency detection comprising:
totaling the zero crossings in the real part of a complex-valued input signal during a predetermined period;
totaling the zero crossings in the imaginary part of the complex-valued input signal during the predetermined period;
comparing the cumulative strength of the real part of the complex-valued input signal with that of the imaginary part of the complex-valued input signal during the predetermined period;
choosing the zero crossings total corresponding to which part of the complex-valued input signal possesses the larger cumulative strength during the predetermined period for use as an effective value; and
determining that there is a high-frequency component in the complex-valued input signal if the effective value exceeds a predetermined threshold.

2. The method of claim 1 wherein the comparing step comprises:
comparing the magnitude of the real part of the complex-valued input signal with that of the imaginary part of the complex-valued input signal on a sample-by-sample basis;
counting the number of samples at which the magnitude of the real part of the complex-valued input signal are greater than or equal to that of the imaginary part of the complex-valued input signal during the predetermined period;
determining whether the count is greater than half the number of samples of the complex-valued input signal within the predetermined period; and
if so, judging that the cumulative strength of the real part of the complex-valued input signal is larger than that of the imaginary part of the complex-valued input signal.

3. The method of claim 1 wherein the comparing step comprises:
measuring S_{I}, the cumulative strength of the real part of the complex-valued input signal during the predetermined period, by:
$${S}_{I} = {\sum }_{n = 0}^{N - 1} {\vert {r}_{I} ( n ) \vert}^{2}$$
where
n denotes a time instant,
N denotes the number of samples of the complex-valued input signal within the predetermined period, and
r_{I}(n) denotes a sample of the real part of the complex-valued input signal at time instant n;
measuring S_{Q}, the cumulative strength of the imaginary part of the complex-valued input signal during the predetermined period, by:
$${S}_{Q} = {\sum }_{n = 0}^{N - 1} {\vert {r}_{Q} ( n ) \vert}^{2}$$
where
r_{Q}(n) denotes a sample of the imaginary part of the complex-valued input signal at time instant n; and
determining which part of the complex-valued input signal possesses the larger cumulative strength during the predetermined period by comparing S_{I} with S_{Q}.

4. The method of claim 1 wherein the comparing step comprises:
measuring S_{I}, the cumulative strength of the real part of the complex-valued input signal during the predetermined period, by:
$${S}_{I} = {\sum }_{n = 0}^{N - 1} \vert {r}_{I} ( n ) \vert$$
where
n denotes a time instant,
N denotes the number of samples of the complex-valued input signal within the predetermined period, and
r_{I}(n) denotes a sample of the real part of the complex-valued input signal at time instant n;
measuring S_{Q}, the cumulative strength of the imaginary part of the complex-valued input signal during the predetermined period, by:
$${S}_{Q} = {\sum }_{n = 0}^{N - 1} \vert {r}_{Q} ( n ) \vert$$
where
r_{Q}(n) denotes a sample of the imaginary part of the complex-valued input signal at time instant n; and
determining which part of the complex-valued input signal possesses the larger cumulative strength during the predetermined period by comparing S_{I} with S_{Q}.

5. A method of automatic gain control in a wireless communications receiver, comprising:
receiving a complex-valued signal;
comparing the cumulative strength of the real part of the complex-valued signal with that of the imaginary part of the complex-valued signal during a predetermined period;
totaling the zero crossings in either the real part or imaginary part of the complex-valued signal during the predetermined period contingent upon which part of the complex-valued signal possesses the larger cumulative strength; and
if the zero crossings total exceeds a predetermined threshold, then
starting to detect a normal packet signal; and
activating a gain control mechanism for regulation of the normal packet signal.

6. The method of claim 5 wherein the comparing step comprises:
comparing the magnitude of the real part of the complex-valued signal with that of the imaginary part of the complex-valued signal on a sample-by-sample basis;
counting the number of samples at which the magnitude of the real part of the complex-valued signal are greater than or equal to that of the imaginary part of the complex-valued signal during the predetermined period;
determining whether the count is greater than half the number of samples of the complex-valued signal within the predetermined period; and
if so, judging that the cumulative strength of the real part of the complex-valued signal is larger than that of the imaginary part of the complex-valued signal.

7. The method of claim 5 wherein the comparing step comprises:
measuring S_{I}, the cumulative strength of the real part of the complex-valued signal during the predetermined period, by:
$${S}_{I} = {\sum }_{n = 0}^{N - 1} {\vert {r}_{I} ( n ) \vert}^{2}$$
where
n denotes a time instant,
N denotes the number of samples of the complex-valued signal within the predetermined period, and
r_{I}(n) denotes a sample of the real part of the complex-valued signal at time instant n;
measuring S_{Q}, the cumulative strength of the imaginary part of the complex-valued signal during the predetermined period, by:
$${S}_{Q} = {\sum }_{n = 0}^{N - 1} {\vert {r}_{Q} ( n ) \vert}^{2}$$
where
r_{Q}(n) denotes a sample of the imaginary part of the complex-valued signal at time instant n; and
determining which part of the complex-valued signal possesses the larger cumulative strength during the predetermined period by comparing S_{I} with S_{Q}.

8. The method of claim 5 wherein the comparing step comprises:
measuring S_{I}, the cumulative strength of the real part of the complex-valued signal during the predetermined period, by:
$${S}_{I} = {\sum }_{n = 0}^{N - 1} \vert {r}_{I} ( n ) \vert$$
where
n denotes a time instant,
N denotes the number of samples of the complex-valued signal within the predetermined period, and
r_{I}(n) denotes a sample of the real part of the complex-valued signal at time instant n;
measuring S_{Q}, the cumulative strength of the imaginary part of the complex-valued signal during the predetermined period, by:
$${S}_{Q} = {\sum }_{n = 0}^{N - 1} \vert {r}_{Q} ( n ) \vert$$
where
r_{Q}(n) denotes a sample of the imaginary part of the complex-valued signal at time instant n; and
determining which part of the complex-valued signal possesses the larger cumulative strength during the predetermined period by comparing S_{I} with S_{Q}.

9. An automatic gain control system comprising:
a high-frequency detector receiving a complex-valued signal and generating a trigger signal, the high-frequency detector comprising:
means for totaling the zero crossings in the real part of the complex-valued signal during a predetermined period;
means for totaling the zero crossings in the imaginary part of the complex-valued signal during the predetermined period;
means for comparing the cumulative strength of the real part of the complex-valued input signal with that of the imaginary part of the complex-valued input signal during the predetermined period;
means for choosing the zero crossings total corresponding to which part of the complex-valued input signal possesses the larger cumulative strength during the predetermined period for use as an effective value; and
means for asserting the trigger signal if the effective value exceeds a predetermined threshold;
a packet detector, responsive to assertion of the trigger signal, for detecting a normal packet signal; and
a gain controller for applying a controlled gain to the detected normal packet signal.

10. The automatic gain control system of claim 9 wherein the comparing means comprises:
means for comparing the magnitude of the real part of the complex-valued signal with that of the imaginary part of the complex-valued signal on a sample-by-sample basis;
means for counting the number of samples at which the magnitude of the real part of the complex-valued signal are greater than or equal to that of the imaginary part of the complex-valued signal during the predetermined period; and
means for determining whether the count is greater than half the number of samples of the complex-valued signal within the predetermined period.

11. The automatic gain control system of claim 10 wherein if the count is greater than half the number of samples of the complex-valued signal within the predetermined period, the choosing means chooses the zero crossings total of the real part of the complex-valued signal.

12. The automatic gain control system of claim 10 wherein the comparing means comprises:
means for measuring S_{I}, the cumulative strength of the real part of the complex-valued signal during the predetermined period, by:
$${S}_{I} = {\sum }_{n = 0}^{N - 1} {\vert {r}_{I} ( n ) \vert}^{2}$$
where
n denotes a time instant,
N denotes the number of samples of the complex-valued signal within the predetermined period, and
r_{I}(n) denotes a sample of the real part of the complex-valued signal at time instant n;
means for measuring S_{Q}, the cumulative strength of the imaginary part of the complex-valued signal during the predetermined period, by:
$${S}_{Q} = {\sum }_{n = 0}^{N - 1} {\vert {r}_{Q} ( n ) \vert}^{2}$$
where
r_{Q}(n) denotes a sample of the imaginary part of the complex-valued signal at time instant n; and
means for determining which part of the complex-valued signal possesses the larger cumulative strength during the predetermined period by comparing S_{I} with S_{Q}.

13. The automatic gain control system of claim 10 wherein the comparing means comprises:
means for measuring S_{I}, the cumulative strength of the real part of the complex-valued signal during the predetermined period, by:
$${S}_{I} = {\sum }_{n = 0}^{N - 1} \vert {r}_{I} ( n ) \vert$$
where
n denotes a time instant,
N denotes the number of samples of the complex-valued signal within the predetermined period, and
r_{I}(n) denotes a sample of the real part of the complex-valued signal at time instant n;
means for measuring S_{Q}, the cumulative strength of the imaginary part of the complex-valued signal during the predetermined period, by:
$${S}_{Q} = {\sum }_{n = 0}^{N - 1} \vert {r}_{Q} ( n ) \vert$$
where
r_{Q}(n) denotes a sample of the imaginary part of the complex-valued signal at time instant n; and
means for determining which part of the complex-valued signal possesses the larger cumulative strength during the predetermined period by comparing S_{I} with S_{Q}.
